(19) United States
(12) Patent Application Publication
(10) Pub. No.: US 2014/0324730 A1
(43) Pub. Date: Oct. 30, 2014

(54) Portfolio Generation

(71) Applicant: Hewlett-Packard Development Company, L.P., (US)

(72) Inventors: Cipriano A. Santos, Palo Alto, CA (US); Haitao Li, St. Louis, MO (US); Maria Teresa Gozalez Diaz, Palo Alto, CA (US); Hiram Trimble Davis, Austin, TX (US); Sergio Alejandro Luis Perez Perez, Tultepec (MX); Fernanco Orozoco, Tlaquepaque (MX); Oliver Fernandez, Tlaquepaque (MX); Claudio Bartolini, Palo Alto, CA (US)

(73) Assignee: Hewlett-Packard Development Company, L.P., Houston, TX (US)

(21) Appl. No.: 13/874,181

(22) Filed: Apr. 30, 2013

(51) Int. Cl. G06Q 40/00

(52) U.S. Cl. CPC G06Q 40/06
USPC 705/36 R

(57) ABSTRACT

A first model is used to generate portfolios that each includes a number of projects. The first model in generating the portfolio optimizes a portfolio value in consideration of objectives under differing bounds of some of the objectives while satisfying constraints. A second model is used to generate an additional portfolio. The second model in generating the additional portfolio optimizes the portfolio value in consideration of the objectives with respect to a priority thereof while satisfying the constraints.

### BACKGROUND

Large enterprises, such as corporations and governments, commonly have to manage internal and external projects, like information technology (IT) and other types of projects, on the order of millions or even billions of dollars in cost on an annual basis. Due to scarce resources, including personnel, time, and money, such enterprises have to carefully select which proposed projects they will actually choose to pursue within a given calendar year or other period of time. A group of projects is referred to and known as a portfolio of projects.

### BRIEF DESCRIPTION OF THE DRAWINGS

FIG. 1 is a flowchart of an example method for generating portfolios of projects using at least a first model and a second model.

FIG. 2 is a flowchart of an example method for using a first model within the method of FIG. 1.

FIG. 3 is a flowchart of an example method using a second model within the method of FIG. 1.

FIG. 4 is a diagram of an example computing system that can implement the method of FIG. 1.

FIG. 5 is a flowchart an example method of use of the computing system of FIG. 4.

### DETAILED DESCRIPTION

As noted in the background, an enterprise has to carefully select which proposed projects to include within a portfolio that it will actually pursue, given limited resources and other constraints. Multiple objectives within the enterprise that are to be desirably satisfied by completion of the projects can make this selection process difficult, particularly where these objectives are competing or in conflict with one another. Manually intensive approaches have typically been employed to select a desired portfolio of projects, but such approaches are cumbersome, and typically do not optimize the objectives even if they satisfy all given constraints.

Disclosed herein are iterative techniques for selecting a portfolio that better optimizes a portfolio value for the portfolio in consideration of potentially conflicting and competing objectives while still satisfying constraints. A number of portfolios are generated using a first model, where each portfolio includes a number of proposed projects. The first model optimizes the portfolio value in consideration of the objectives under differing bounds thereof, while satisfying the constraints. An additional portfolio is generated using a second model, which optimizes the portfolio value in consideration of the objectives with respect to the objectives as prioritized, again while satisfying the constraints. Until a desired portfolio is selected, this process can be iterative, where portfolios are regenerated using the first and/or second models and/or are optimized using a third model after, for instance, modifying the constraints, the bounds, or the prioritization of the objectives.

The techniques disclosed herein are described in example relation to four particular objectives, although other implementations of these techniques can employ more or fewer objectives, as well as the same and/or different objectives. A first objective is a primary project ranking. For example, in some organizations, an executive council may rank each proposed project that is under consideration for inclusion within the portfolio of projects that the organization actually pursues. Each proposed project may have a unique ranking, such that the proposed projects are ranked from most desired to least desired, or each proposed project may have a non-unique ranking selected from a limited number of rankings, such as from one to ten, and so on.

A second objective is a secondary project ranking. For example, in some organizations, each of a number of business councils may rank the proposed projects that it proposed or that fall under its domain. For instance, there may be N business councils, and each business council may rank just those proposed projects that it proposed, that will benefit the business council in question, or that it will manage. As with the primary project ranking objective, each proposed project may have a unique or non-unique ranking within the secondary project ranking objective as well.

A third objective is project benefit. The benefit of each proposed project, irrespective of implementation costs, may be provided in monetary terms and normalized for a common time period, such as annually. A fourth objective is ratio of project benefit to project cost. The aforementioned benefit of each proposed project is divided by the monetary and/or other cost to implement the project. The resulting quotient is the ratio of project benefit to project cost.

The portfolio value that is optimized can be a total net present value of benefits derived from effectuating the projects of the portfolio, in monetary or other terms. Optimizing the portfolio value can include maximizing the portfolio value, such as maximizing the total net present value of the benefits, by optimally scheduling the projects in relation to the resources that the projects use to be completed. Such optimal scheduling is referred to as optimizing the portfolio. There is thus a portfolio value for each portfolio of projects that is generated, and a corresponding optimization of each portfolio in terms of how the projects of each portfolio are scheduled with respect to resource utilization.

The constraints in relation to which the portfolio value is optimized in consideration of the objectives can include a variety of differing constraints. Such constraints typically relate to scarce resources. Such scarce resource-related constraints can include monetary, or budget or cost, constraints, as well as personnel, or headcount, constraints. The scarce resource-related constraints also can include timing constraints, such as long how a project will take to implement, the time window of a project, and time-dependencies among projects. The constraints may include other types of constraints as well, in addition to and/or in lieu of monetary, personnel, and/or timing constraints.

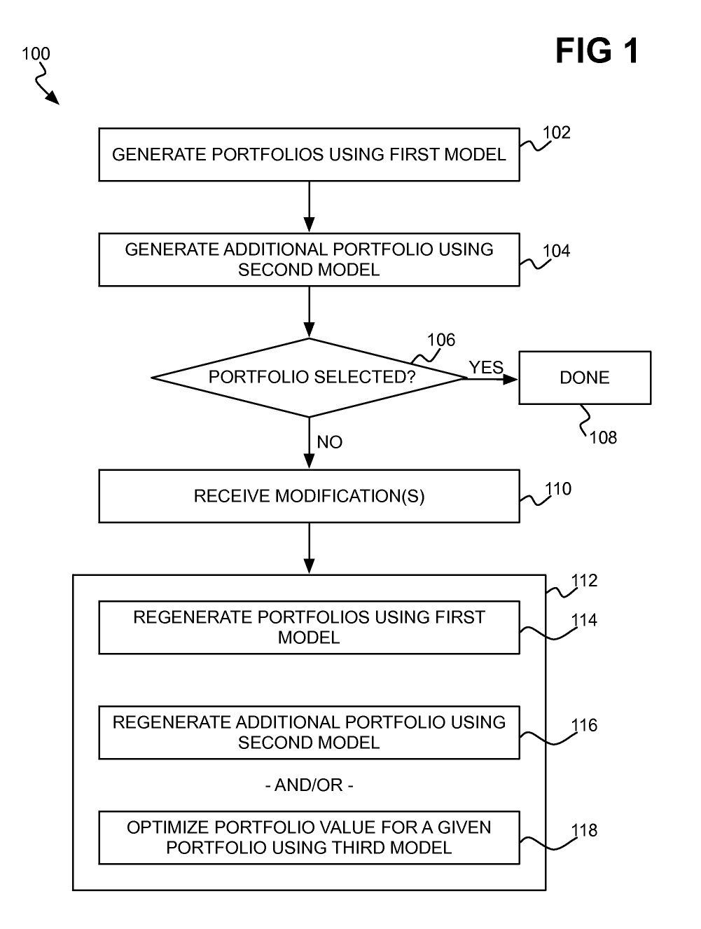

FIG. 1 shows an example method 100 for generating portfolios of projects among which a desired portfolio can be selected for actual implementation. The method 100 can be implemented as a computer program that a processor of a computing device, like a general-purpose computer, executes to perform the method 100. The computer program may be stored on a non-transitory computer-readable data storage medium, such as volatile or non-volatile semiconductor, magnetic, and/or optical media.

A first model is used to generate a number of portfolios (102). These portfolios may be considered the baseline portfolios that can be subsequently selected from, modified, and so on, to yield a desired portfolio for actual implementation. Of a pool of proposed projects, each of which has been classified in accordance with the objectives described above, each portfolio includes a different combination of the projects.

In general, the first model is used to generate the portfolios by optimizing the portfolio value in consideration of the objectives under differing bounds of some of the objectives while satisfying the constraints. For instance, to generate the baseline portfolios, the first model may consider differing bounds of the primary and secondary project rankings while optimizing the portfolio value. As a concrete example, where each of the primary and the secondary project ranking objectives includes each project having been rated between one (most important) and ten (least), the first model may consider predetermined bounds between one and five for the primary project ranking and between one and three for the secondary project ranking.

Each unique combination of the primary and secondary project rankings between the corresponding bounds is considered when optimizing the portfolio value to generate a corresponding portfolio of projects. As such, the result of optimizing the portfolio value in consideration of each such combination of the primary and secondary project rankings between the bounds is the generation of a number of portfolios using this first model. An example of the first model is mathematically described later in the detailed description.

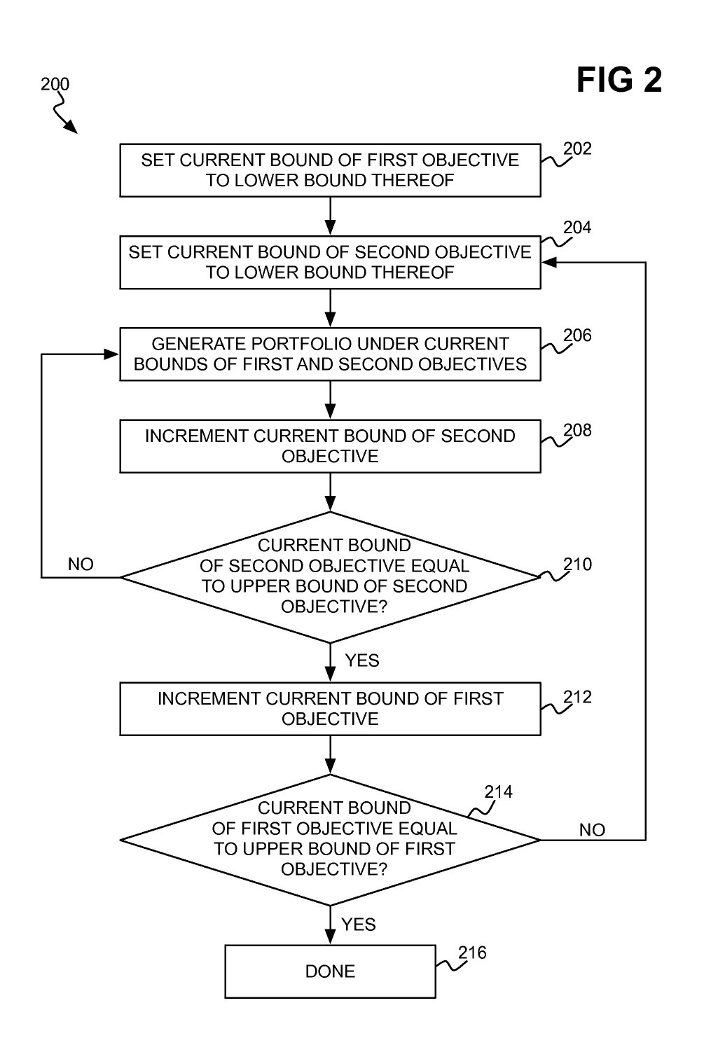

FIG. 2 shows an example method 200 for generating the portfolios using the first model. The method 200 can thus implement part 102 of the method 100. The method 200 generates the portfolios by optimizing the portfolio value in consideration of a pair of objectives under differing bounds thereof. This pair of objectives is said to include a first objective and a second objective in the description of the method 200. Each of these two objectives has a lower bound and an upper bound, which may be the same or different for the two objectives.

A current bound of the first objective is set to the lower bound of the first objective (202), and a current bound of the second objective is set to the lower bound of the second objective (204). A portfolio is generated under these current bounds of the two objectives, while satisfying the constraints (206). The current bound of the second objective is incremented (208). If the current bound of the second objective is not yet equal to the upper bound of the second objective (210), then the method 200 is repeated at part 206, at which another portfolio is generated under the same current bound of the first objective and under the new current bound of the second objective.

Once the current objective of the second objective becomes equal to the upper bound of the second objective (210), then the method 200 proceeds to increment the current bound of the first objective (212). If the current bound of the first objective is not yet equal to the upper bound of the first objective (214), then the method 200 is repeated at part 204, at which the current bound of the second objective is reset to its lower bound, and new portfolios generated under the new current bound of the first objective and under each bound of the second objective. Once the current bound of the first objective becomes equal to the upper bound of the first objective (214), then the method 200 is finished, resulting in the generation of the portfolios using the first model.

Referring back to FIG. 1, a second model is used to generate an additional portfolio (104). The additional portfolio is also one of the baseline portfolios that can be subsequently selected from, modified, and so on, to yield a desired portfolio for actual implementation. The additional portfolio generated using the second model includes a combination of projects from the same pool of proposed projects that the first model employed.

In general, the second model is used to generate the additional portfolio by optimizing the portfolio value in consideration of the objectives with respect to a predetermined prioritized ordering thereof, while satisfying the constraints. The prioritized ordering of the objectives, which is referred to as a priority of the objectives, has a default ranking of the objectives that can be subsequently modified. For example, the four objectives described above may be ranked in priority from highest to lowest by default as primary project ranking, secondary project ranking, project benefit, and project benefit-to-project cost ratio.

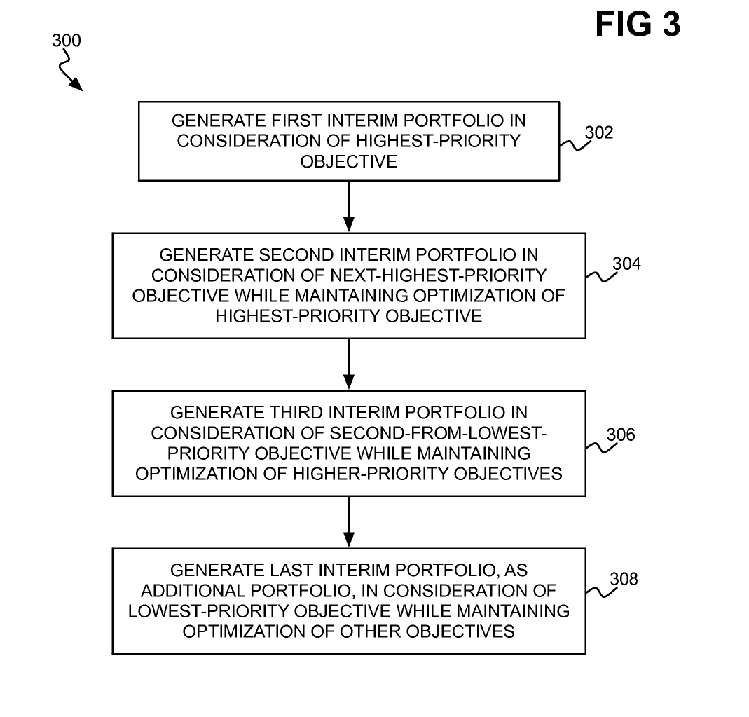

FIG. 3 shows an example method 300 for generating the additional portfolio using the second model. The method 300 can thus implement part 104 of the method 100. The method 300 generates an initial portfolio that optimizes the portfolio value in consideration of the primary project ranking objective (or other highest priority objective), and which results in this objective being optimized as well (302). The method 300 in a second iteration generates an interim portfolio that optimizes the portfolio value in consideration the secondary project ranking objective (or other next highest priority objective) without regard to the lower priority objectives, while maintaining optimization of the highest priority objective (304). The second iteration results in the second highest priority objective being optimized as well.

The method 300 in a third iteration generates another interim portfolio that optimizes the portfolio value in consideration of the project benefit objective (or other third highest priority, or second from lowest priority, objective) without regard to the lowest priority objective, while maintaining optimizations of the higher priority objectives (306). The third iteration results in the third highest priority objective being optimized as well. The method 300 in a final iteration generates the additional portfolio (i.e., the last interim portfolio) as maximizing the lowest priority objective of project benefit-to-project cost ratio, while maintaining optimizations of the higher priority objectives, and results in the lowest priority objective being optimized as well (308). An example of the second model is mathematically described later in the detailed description.

Referring back to FIG. 1, if one of the portfolios that have been generated is selected for actual implementation, then the method 100 is finished (108). Otherwise, an iterative approach is performed. One or more modifications are received (110), and in part 112, the portfolios are regenerated using the first model (114), the additional portfolio is regenerated using the second model (116), or the portfolio value for a given portfolio that has been previously generated but which has been modified is optimized using a third model (118). The method 100 is then repeated at part 106, until a generated portfolio has been selected for actual implementation such that the method 100 is finished (108).

The modifications on which basis the first model regenerates the portfolios can include modifications to the differing bounds, which objectives are considered in relation to the differing bounds, and the constraints themselves. The modifications on which basis the second model regenerates the additional portfolio can include the priority of the objectives, and the constraints as well. The modifications on which basis a third model is used to optimize the portfolio value for a given portfolio includes the projects that make up the given portfolio, and can also include the constraints themselves.

The third model can be the foundation for the first and second models, as described later in the detailed description. An already generated portfolio may be modified in the projects that make up the portfolio, such as by adding different projects to the portfolio or removing existing projects from the portfolio, and the third model run in part 118 to assess how this modification affects the optimized portfolio value thereof. An example of the third model is mathematically described later in the detailed description.

The method 100 provides a way by which portfolios of projects can be generated and compared over one or more iterations to result in a desired portfolio that is selected for actual implementation. The baseline portfolios generated in parts 102 and 104 may provide a sufficient variety of optimal portfolios to select from to make a reasoned and informed decision as to the portfolio of projects that should be implemented. If not, then the portfolio(s) can be regenerated in part 112 on the basis of differing modifications received in part 110 so that various types of “what if” analyses can be performed to yield an optimal portfolio of projects that is selected for actual implementation. The iterative loop within the method 100 of parts 106, 110, and 112 may be performed a number of times, for instance, until a portfolio of projects is agreed upon for actual implementation.

As noted above, the method 100 employs a first model and a second model to generate portfolios, and a third model to optimize the portfolio value of a given portfolio. As also noted above, the third model can effectively serve as the foundation for the first and second models. The following description presents, after defining some mathematical terms, example mathematical implementations of the third, second, and first models, in that order, which can be used in conjunction with the method 100.

A portfolio is said to contain a set M of projects. Each project mεM has a planned annualized benefit πₘ that incurs during the first twelve months, or another period of time, after project completion, plus any pre-completion benefits. Project m is associated with primary project ranking ρₘ^{EC} and a secondary project ranking ρₘ^{DC}. A threshold on the average primary project ranking of the selected projects is L^{EC}; the threshold on the average secondary project ranking of the selected projects is L^{DC}.

Each project mεM includes a set Yₘ of phases, milestones, subtasks, and so on, which are generally referred to as activities. A directed graph G(V,E) is defined with V denoting the set of all project phases, such that V=Y₁∪Y₂ . . . ∪Y_{|M|}, and E being the set of arcs in the graph. Each directed arc (i,j)εE represents a precedence relationship between phase i and j, such that phase j cannot start until phase i is completed. Phase i has a planned release, or start, date λᵢ and due date dᵢ. The due date can be specified by a contract, for instance, or as a way for pushing or shifting benefits in or out of a given fiscal year or other period of time. A target duration pᵢ is estimated for phase i.

Phase i uses rᵢₖₜ units of resources of type kεK in time period tεT. K is the set of resource types involved in the portfolio, which may include budget and workforce (i.e., personnel) with different roles, for instance, and T is the entire planning horizon. The capacity of resource kεK available in time period tεT is Qₖₜ.

The third model in an example implementation is a basic optimization model (BOM) that maximizes the total net present value (NPV) of benefits derived from a selected portfolio, while satisfying the constraints. Such constraints can include project release and due date constraints, budget and labor constraints, minimum percentage of selected projects of a particular grouping or groupings of projects. For primary and secondary project rankings of a project, a value of 1 means the best ranking. A maximum average ranking threshold is imposed for the selected portfolio to set up an upper bound on the importance of primary and secondary project rankings that are willing to be given up (i.e., not selected for implementation).

A binary-integer programming (BIP) formulation for the BOM is as follows. The following sets are defined within the BIP formulation.

H: set of project types

Mₕ: set of projects of type hεH

M: set of all projects M=M₁ ∪ M₂ . . . ↑ M_{|H|}

L: set of binary logical constraints, each of which involves two projects m₁>m₂

Yₘ: set of phases, milestones, subtasks, or other activities in project m. An index 0εYₘ denotes the dummy start of project m, and an index yεYₘ denotes the dummy finish of m.

V: set of all activities modeled as vertices (that is, nodes) in a directed graph, i.e., V=Y₁ ↑ Y₂ . . . ↑ Y_{|M|}

E: set of edges (arcs) in the directed graph

K^{r}: set of resources that are renewable, in that the capacity for which is renewed each time period. An example of a renewable resource is personnel or labor, such as various skilled workforce.

Kⁿ: set of resources that are non-renewal, in that the capacity for which is constrained for the entire planning horizon. Examples include money, capital budget, consumable materials, and so on.

T: set of time periods in the planning horizon

S: set of projects directly selected by a user like a portfolio manager

NS: set of projects that cannot be selected in a current scenario

The following parameters are defined in the BIP formulation of the BOM.

α: a positive discounting factor

θₕ: minimum percentage of type hεH projects in the portfolio

pₘᵢ: estimated deterministic duration of activity iεV in project mεM

δₘᵢ^{m′i′}: minimal time lag between a pair of activities (mi,m′i′)εE, i.e. activity i′ in project m′ cannot start until at least δₘᵢ^{m′i′} time units after activity i in project m starts. As such, when δₘᵢ^{m′i′}=pₘᵢ, the generalized temporal constraint reduces to a standard precedence constraint. When m=m′, the temporal constraints involve just activities within a project; when m≠m′, the constraints model time dependencies among activities across projects.

λₘ: release date of project mεM

dₘ: due date of project mεM

πₘ: planned annualized benefit that incurs during the twelve months, or other period, after project completion

Qₖⁿ: amount of non-renewable resource kεKⁿ available

Qₖₜ^{r}: units of renewable resource kεK^{r} available in time period tεT

rₘᵢₖₜ: units of renewable resource kεK^{r} needed by activity i of project m in the t-th period of activity i's duration

φₘᵢₖ: consumption of non-renewable resource kεKⁿ by activity i in project m

ρₘ^{EC}: primary project ranking of project mεM. A low ranking value means higher priority.

ρₘ^{DC}: secondary project ranking of project mεM. A low ranking value means higher priority

β^{EC}: threshold for the maximum average primary project ranking of the selected portfolio

β^{DC}: threshold for the maximum average secondary project ranking of the selected portfolio

ESₘᵢ: earliest starting time of activity i in project m

LSₘᵢ: latest starting time of activity i in project m

[ESₘᵢ, LSₘᵢ] defines the time window of activity i in project m, which can be obtained by temporal analysis in project scheduling. λₘ and dₘ can be used to obtain feasible time windows.

The following decision variables are defined in the BIP formulation of the BOM.

yₘ=1 if project m is selected in the portfolio; and 0 otherwise.

xₘᵢₜ=1 if activity i of project m starts at time period t; and 0 otherwise.

The objective function for the BIP formulation of the BOM is to maximize the total expected benefit in terms of NPV:

Max Σ_{mεM}Σ_{t=ES}_{_{my}}^{LS}^{_{my}}x_{m|Y}_{ₘ}_{|t}πₘ/(1+α)^{t-ES}^{_{my}} (1)

The total expected benefit is maximized subject to the following constraints.

s.t. Σ_{mεM}_{ₕ}yₘ≧θₕ·Σ_{mεM}yₘ ∀hεH (2-1)

Σ_{mεM}_{ₕ}(yₘ·Σ_{iεY}_{ₘ}Σ_{kεK}_{^{r}}Σₜ₌₀^{p}^{ₘᵢ}rₘᵢₖₜ)≧θₕ·Σ_{mεM}(yₘ·Σ_{iεY}_{ₘ}Σ_{kεK}_{^{r}}Σₜ₌₀^{p}^{ₘᵢ}rₘᵢₖₜ)

∀hεH (2-2)

Σ_{mεM}_{ₕ}(yₘ·Σ_{iεY}_{ₘ}Σ_{kεK}_{ⁿ}φₘᵢₖ)≧θₕ·Σ_{mεM}(yₘ·Σ_{iεY}_{ₘ}Σ_{kεK}_{ⁿ}φₘᵢₖ)

∀hεH (2-3)

yₘ=1 ∀mεS (3-1)

yₘ=0 ∀mεNS (3-2)

Σ_{mεM}Σ_{iεY}_{ₘ}φₘᵢₖyₘ≦Qₖⁿ∀kεKⁿ (4)

ρₘ^{EC}·yₘ≦β^{EC}Σ_{mεM}yₘ ∀mεM (5-1)

ρₘ^{DC}·yₘ≦β^{DC}Σ_{mεM}yₘ ∀mεM (5-2)

f(yₘ₁,yₘ₂)≦bₘ₁ₘ₂ ∀(m₁,m₂)εL (6)

Σ_{iεY}_{ₘ}Σ_{t=ES}_{ₘᵢ}^{LS}^{ₘᵢ}xₘᵢₜ=yₘ ∀mεM (7)

Σ_{t=ES}_{_{m′i′}}^{LS}^{_{m′i′}}t·x_{m′i′t′}+T·(1−y_{m′})−Σ_{t=ES}_{ₘᵢ}^{LS}^{ₘᵢ}t·xₘᵢₜ≧δₘᵢ^{m′i′}·yₘ

∀(mi,m′i′)εE (8-1)

Σ_{t=ES}_{ₘᵢ}^{LS}^{ₘᵢ}t·xₘ₀ₜ≧λₘyₘ ∀mεM (8-2)

Σ_{t=ES}_{ₘᵢ}^{LS}^{ₘᵢ}t·x_{myt}≦dₘyₘ ∀mεM (8-3)

Σ_{mεM}Σ_{iεY}_{ₘ}Σ_{τ=max}^{min{LS}^{ₘᵢ}^{,t}}r_{mik,t-τ}x_{miτ}≦Qₖₜ^{r}

∀kεK^{r},tε{0, . . . ,T} (9)

xₘᵢₜε{0,1} ∀mεM,iεYₘ,tε{ESₘᵢ, . . . ,LSₘᵢ} (10)

yₘε{0,1} ∀mεM (11)

The objective function (1) maximizes the total expected annualized benefit of the portfolio. It is generated as an NPV of the selected project portfolio, so that each project will be scheduled at its earliest possible start time to avoid unnecessary delay. Project m's NPV is discounted by the start time of its last (dummy end) activity |Yₘ|.

Constraints (2-1) through (2-3) shape the mix of different project types in the portfolio, where the percentage of type h project is at least θₕ among all the selected projects. Specifically, constraint (2-1) satisfies this requirement in terms of the number of selected projects; constraint (2-2) satisfies it in terms of headcounts (i.e., number of personnel) required; and constraint (2-3) satisfies it in terms of budget required.

Constraint (3-1) allows a user like a portfolio manager to directly select projects, and constraint (3-2) makes it possible to directly de-select projects. Constraint (4) ensures that the total consumption of non-renewable resource such as money and budget cannot exceed the available amount. Constraints (5-1) and (5-2) enforce the threshold on the average primary and secondary project rankings, respectively. That is, the averages of the primary and secondary project rankings are not greater than their thresholds β^{EC} and β^{DC}, respectively. Since a ranking value of 1 is the best ranking, being no greater than the threshold implies that lower ranked projects cannot be selected.

Constraint (6) represents a logical constraint on a pair of projects (m1, m2). The left hand side f(•) of (6) is a linear function of the choice decision variables yₘ₁, yₘ₂. Depending upon different forms of f(•) and the right hand side constant b, constraint (6) can be used to model various logical requirements among projects. For instance, y₂−y₁≦0 means that project 2 cannot be selected unless project 1 has been selected (prerequisite relationship); y₂+y₁≦1 means that project 1 and project 2 cannot be simultaneously selected (exclusive relationship). However, the formulation does not restrict the possibility that f (•) may be a function of more than two decision variables.

Additional propositional logical constraints may include a both-or-nothing and all-or-nothing constraint. For instance, a user may want to select both projects m and m′ or none of the two, such that yₘ=y_{m′} can be imposed. The transitive property of this relationship permits for modeling of an all-or-nothing constraint for a set of projects {1, 2, . . . , a} in this way: y₁=yₘ, ∀m=2, . . . , a.

Usage of the logical relationships permits selection of different options of the same project. For example, project m may have N different ways (i.e., options) o=1, 2, . . . , N to be executed, which may differ in benefit, duration, and resource usage. A user may want to select a best option among the N alternatives. To support such decision, N replicates of the same project may be created, with each replicate o carrying the data information associated with the option. The replicates are treated in the same way with other projects in the portfolio, with an additional logical constraint that exactly one option will be chosen for project m, i.e. Σₒ₌₁^{N}yₒ=1.

Constraint (7) schedules the activities of a selected project to start at exactly one time period, such that once started an activity cannot be interrupted. When yₘ=0, there is no need to schedule project m. Constraints (8-1) through (8-3) satisfy the temporal constraints among project activities. Specifically, constraint (8-1) guarantees that the minimum time lag between a pair of activities (mi, m′i′), i.e. activity m′i′ cannot start until at least δₘᵢ^{m′i′} time units after activity mi starts. Constraints (8-2) and (8-3) satisfy the release (i.e., start) date and due date of a project, respectively.

Constraint (9) enforces the renewable resource constraint: for each type k of renewable resource and at any time period t, the total required capacity cannot exceed the available capacity Qₖₜ^{r} of renewable resource k at t. The formulation of constraint (9) models varying resource requirements by project tasks. In this formulation, r_{mik,t-τ} on the left-hand side of constraint (9) is determined, which translates the nominal period t into the (t−τ)-th period of the task's duration, if the task is started at period τ. Constraints (10) defines the time-indexed binary variable x. Constraint (11) ensures that the selection decision variable y is binary.

It is noted that the BOM example implementation of the third model is NP-complete. This is because the BOM reduces to a single-mode resource-constrained project scheduling problem (RCPSP) when the project selection decision is fixed. In this respect, it is noted that a feasible solution to a single-model RCPSP is known to be NP-complete.

The second model in an example implementation is a multi-criteria ranking optimization model (MCROM). The second model in this example implementation is based on the BOM that has been described. The second model considers a prioritization of the multiple objectives, which is referred to as the priority of the objectives. A default priority is, from highest priority to lowest priority, the primary project ranking, followed by the secondary project ranking, the project benefit, and the ratio of project benefit to project cost. The following description of the MCROM assumes this default priority, but it can be modified by a user, for instance, or the objectives can be preset by default in a different way.

The MCROM considers the same constraints as the BOM. The MCROM first finds a portfolio that maximizes the total NPV of the primary project ranking. In a second iteration, the MCROM fixes the optimal value of the primary project ranking as a new constraint, and finds a portfolio that maximizes the total NPV of the secondary project ranking. For a third iteration, the MCROM fixes the optimal values of the primary and secondary project rankings as constraints in the model, and finds a portfolio that maximizes the total NPV of the project benefit. In a final iteration, the MCROM fixes the optimal value of the primary and secondary project rankings and of the project benefit as constraints in the model, and finds a portfolio that maximizes the total NPV of the ratio of project benefit to project cost.

Mathematically, A={a₁, a₂, . . . , aₙ} is a set of n criteria with a pre-specified ordering to be optimized. The order of importance is: a₁>a₂ . . . >aₙ. The MCROM can be implemented via the following pseudo code, which is an example implementation of the method 300 of FIG. 3 that has been described.

### Procedure_Constraint_Method (BIPModel, A)

While i≦n

Step 1. Set up the BIPModel with the objective function of optimizing criteria aᵢ

Step 2. If 1<i<n, then
Add a new constraints enforcing criteria aᵢ₋₁ to achieve no worse than Oᵢ₋₁*
End If

Step 3. Solve BIPModel and record its objective value Oᵢ*

Step 4. Increment i:=i+1

### End While

### End Procedure

This procedure starts with the BOM formulation with no objective function, that is, with the constraints (2) through (11) noted above. In the first iteration, an objective function to optimize the primary project ranking is included in the formulation. Directly minimizing the average ranking can be problematic because one optimal solution is to select no projects, with an “optimal” ranking of zero. To resolve this issue, the priority ranking is recoded such that a higher ranking value means higher priority:

ρ′ₘ=Γ−ρₘ ∀mεM (12)

For each project m, its ranking ρ′ₘ is recoded as the difference between an upper bound ranking value Γ and its current ranking ρₘ.

Next, the total (recoded) primary project ranking of all selected projects is maximized in (13) in the first iteration. These rankings are discounted in the same way as in (1) to prevent a project from being unnecessarily delayed.

Max Σ_{mεM}Σ_{t=ES}_{_{my}}^{LS}^{_{my}}xₘᵢₜρ′ₘ^{EC}/(1+α)^{t-ES}^{_{my}} (13)

For example, if the optimal objective value maximizing (13) is LO*(EC), an achievement constraint (13′) guaranteeing that the total discounted primary project ranking is no less than LO*(EC) is added to the constraint set.

Σ_{mεM}Σ_{t=ES}_{_{my}}^{LS}^{_{my}}xₘᵢₜρ′ₘ^{EC}/(1+α)^{t-ES}^{_{my}}≧LO*(EC) (13′)

In the second iteration, the total (recoded) secondary project ranking of all selected projects is maximized, in (14):

Max Σ_{mεM}Σ_{t=ES}_{_{my}}^{LS}^{_{my}}xₘᵢₜρ′ₘ^{DC}/(1+α)^{t-ES}^{_{my}} (14)

For example, if the optimal objective value maximizing (14) is LO*(DC), then a second achievement constraint (14′) guaranteeing that the total discounted secondary project ranking is no less than LO*(DC) is added to the constraint set.

Σ_{mεM}Σ_{t=ES}_{_{my}}^{LS}^{_{my}}xₘᵢₜρ′ₘ^{DC}/(1+α)^{t-ES}^{_{my}}≧LO*(DC) (14′)

In the third iteration, the total project benefit is maximized in (15), as in (1):

Max Σ_{mεM}Σ_{t=ES}_{_{my}}^{LS}^{_{my}}xₘᵢₜπₘ/(1+α)^{t-ES}^{_{my}} (15)

If the optimal objective value maximizing (15) is LO*(π), then a third achievement constraint (15′) guaranteeing that the total discounted project benefit is no less than LO*(π) is added.

Σ_{mεM}Σ_{t=ES}_{_{my}}^{LS}^{_{my}}xₘᵢₜπₘ/(1+α)^{t-ES}^{_{my}}≧LO*(π) (15′)

In the last (fourth) iteration, the total project benefit-to-project cost ratio of all selected projects is maximized. The project benefit-to-project cost ratio ωₘ of a project m is:

ωₘ=πₘ/Σ_{iεY}_{ₘ}Σ_{kεK}_{ⁿ}φₘᵢₖ ∀mεM, (16)

where the denominator is the sum of consumption of all non-renewable resources by the project. As such, objective function (17) maximizes the total discounted project benefit-to-project cost ratio:

Max Σ_{mεM}Σ_{t=ES}_{_{my}}^{LS}^{_{my}}xₘᵢₜωₘ/(1+α)^{t-ES}^{_{my}} (17)

Because this is the last criteria in the list, the procedure terminates without adding any additional constraints.

The first model in an example implementation is a Pareto optimization model (POM). The first model in this example implementation is also based on the BOM that has been described. The first model explores optimal trade-offs between different objectives, such as the primary and secondary project rankings. The BOM formulation (1) through (11) serves as the base model for POM. For each pairwise comparison the objective is to maximize the NPV of the total benefits, considering the BOM constraints, and systematically setting bounds on the two objectives to be compared. The bound of each objective has a minimum value, a maximum value, and a step size value. The POM model is solved multiple times considering all the combinations of bounds values.

The POM can be implemented via the following pseudo code, which is an example implementation of the method 200 of FIG. 2 that has been described. The following input arguments are defined.

a: attribute a

b: attribute b

lbₐ: lower bound of attribute a

ubₐ: upper bound of attribute a

lb_{b}: lower bound of attribute b

ub_{b}: upper bound of attribute b

δₐ: step size of attribute a

δ_{b}: step size of attribute b

The pseudo code is thus as follows.

```
Procedure_Constraint_Method (MIPModel, lbₐ, ubₐ, lb_{b}, ub_{b}, δₐ, δ_{b})
Step 0. Initialization
    Set ā := lbₐ, b̅ := lb_{b}
Step 1. Main Iteration
    While ā ≦ ubₐ
        While b̅ ≦ ub_{b}
            1.1. Solve MIPModel using a and b as the right-hand side
of the two corresponding constraints
            1.2. Output and record results
            1.3. Increment b̅ := b̅ + δ_{b}
        End While
        ā := ā + δₐ
    End While
End Procedure
```

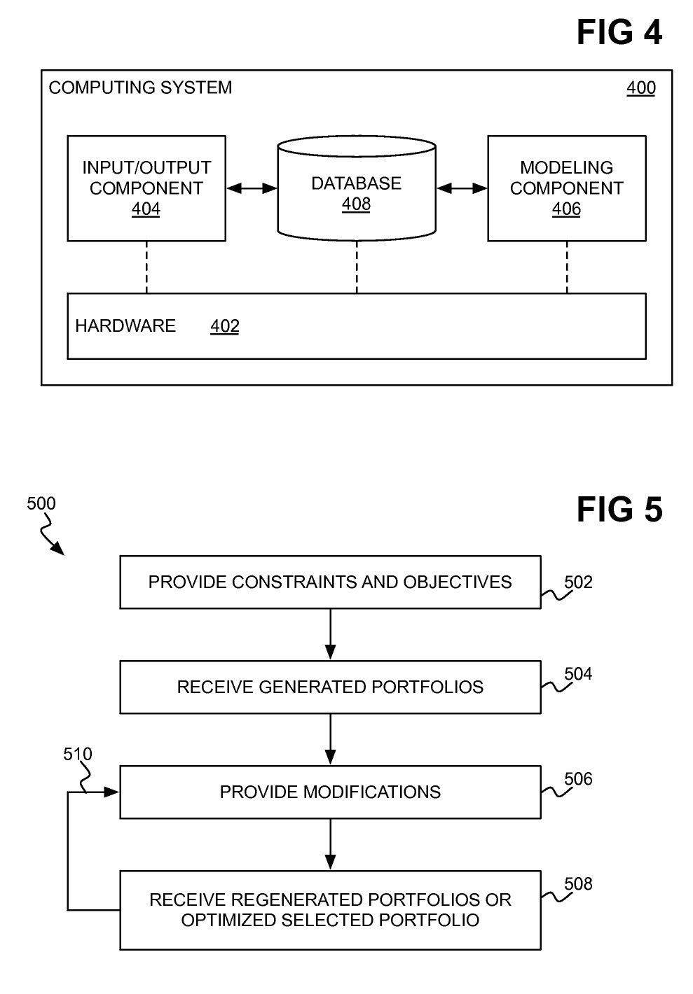

FIG. 4 shows an example computing system 400 that can implement the methods 100, 200, and 300 that have been described. The system 400 can itself be implemented as one or more computing devices. In general, the computing system 400 includes hardware 402, which typically includes one or more processors, volatile and non-volatile computer-readable media, as well as other types of hardware. The hardware 402 implements an input/output component 404 and a modeling component 406. Each component 404 and 406 may be a computer program(s) stored on computer-readable media and executable by processors. The hardware 402 also implements a database 408.

A user interacts with the computing system 400 via the input/output component 404. The input/output component 404 stores the constraints, the objectives, the priority of the objectives, and the portfolios of projects themselves on the database 408. The component 404 further permits modification of the constraints, the objective, the priority of the objectives, and the portfolios by a user, and outputs the portfolios generated in accordance with the methods 100, 200, and 300. For instance, the input/output component 404 may visualize the portfolios that are generated as a three-dimensional map of points representing the portfolios, where a user can select each point on the map to acquire detailed information regarding the corresponding portfolio, including the projects that make up the portfolio, and so on.

The modeling component 406 generates the portfolios of projects in accordance with the methods 100, 200, and 300, based on the information stored in the database 408. That is, the modeling component 406 performs at least some parts of the methods 100, 200, and 300 in one example implementation. As such, after the modeling component 406 generates the baseline portfolios, the input/output component 404 can receive modifications from a user, responsive to which the modeling component 406 regenerates the portfolios, optimizes a modified portfolio, and so on.

FIG. 5 shows an example method 500 for using the computing system 400 that implements the methods 100, 200, and 300. A user can provide at least constraints and objectives regarding projects to the computing system 400 (502). In response, baseline portfolios are received back from the system 400 (504). For instance, the computing system 400 may display the initially generated portfolios for viewing by the user. The user in turn can provide one or more different types of modifications to the computing system 400 (506), and responsively receive regenerated portfolios and/or an optimized portfolio selected by the user (508), as has been described. Parts 506 and 508 can be repeated as desired, as indicated by the arrow 510, until a given portfolio has been chosen for actual implementation.

We claim:

1. A non-transitory computer-readable data storage medium storing a computer program executable by a processor of a computing device to perform a method comprising:
generating a plurality of portfolios using a first model, each portfolio of the plurality of portfolios including a sub-plurality of a plurality of projects, each portfolio generated using the first model optimizing a portfolio value in consideration of a plurality of objectives under differing bounds of a sub-plurality of the objectives while satisfying a plurality of constraints; and
generating an additional portfolio of the plurality of portfolios using a second model, the additional portfolio optimizing the portfolio value in consideration of the objectives with respect to a priority of the objectives while satisfying the constraints.

2. The non-transitory computer-readable data storage medium of claim 1, wherein the method further comprises:
receiving a modification of one or more of the differing bounds, which of the objectives are part of the sub-plurality of the objectives, and the constraints; and
regenerating the portfolios using the first model after the modification has been received.

3. The non-transitory computer-readable data storage medium of claim 1, wherein the method further comprises:
receiving a modification of one or more of the priority of the objectives, and the constraints; and
regenerating the additional portfolio using the second model after the modification has been received.

4. The non-transitory computer-readable data storage medium of claim 1, wherein the method further comprises:
receiving a modification of which of the sub-plurality of the projects make up a selected portfolio of the portfolios; and
optimizing the portfolio value for the selected portfolio using a third model, while satisfying the constraints, after the modification has been received.

5. The non-transitory computer-readable data storage medium of claim 4, wherein the method further comprises:
receiving a modification of the constraints,
wherein the portfolio value is optimized for the selected portfolio using the third model also after the modification of the constraints has been received.

6. The non-transitory computer-readable data storage medium of claim 1, wherein the sub-plurality of the objectives comprises a first objective and a second objective of the objectives, and generating the portfolios using the first model comprises:
for each of a plurality of bounds of the first objective from a lower bound of the first objective to an upper bound of the first objective,
for each of a plurality of bounds of the second objective from a lower bound of the second objective to an upper bound of the second objective,
generating one of the portfolios.

7. The non-transitory computer-readable data storage medium of claim 1, wherein the sub-plurality of the objectives comprises a first objective and a second objective of the objectives, and generating the portfolios using the first model comprises:
setting a current bound of the first objective to a lower bound of the first objective;
repeatingly:
setting a current bound of the second objective to a lower bound of the second objective;
repeatingly:
generating one of the portfolios under the current bound of the first objective and under the current bound of the second objective while satisfying the constraints;
incrementing the current bound of the second objective,
until the current bound of the second objective reaches an upper bound of the second objective;
incrementing the current bound of the first objective,
until the current bound of the first objective reaches an upper bound of the first objective.

8. The non-transitory computer-readable data storage medium of claim 1, wherein the objectives comprise a first objective and a second objective, the first objective having higher priority than the second objective, and generating the additional portfolio using the second model comprises:
generating a first interim portfolio that optimizes the portfolio value in consideration of the first objective while satisfying the constraints, resulting in an optimization of the first objective;
generating a second interim portfolio that optimizes the portfolio value in consideration of the second objective while satisfying the constraints and while maintaining the optimization of the first objective, resulting in an optimization of the second objective,
wherein a last interim portfolio generated is the additional portfolio.

9. The non-transitory computer-readable data storage medium of claim 8, wherein the objectives further comprise a third objective having a lower priority than the second objective, and generating the additional portfolio using the second model comprises:
generating a third interim portfolio using the third model that optimizes the portfolio value in consideration of the third objective while satisfying the constraints and while maintaining the optimization of the first objective and the optimization of the second objective.

10. The non-transitory computer-readable data storage medium of claim 1, wherein:
the first model is a Pareto optimization model that is based on a basic optimization model, and
the second model is a multiple-criteria ranking optimization model that is also based on the basic optimization model.

11. A method comprising:
providing a plurality of constraints and a priority of a plurality of objectives to a computing device; and
receiving from the computing device a plurality of portfolios including a plurality of first portfolios and a second portfolio, each portfolio including a sub-plurality of a plurality of projects,
wherein each first portfolio is generated by the computing device using a first model optimizing a portfolio value in consideration of the objectives under differing bounds of a sub-plurality of the objectives while satisfying the constraints,
and wherein the second portfolio is generated by the computing device using a second model optimizing the portfolio value in consideration of the objectives with respect to the priority of the objectives while satisfying the constraints.

12. The method of claim 11, further comprising:
providing to the computing device a modification of one or more of the differing bounds, which of the objectives are part of the sub-plurality of the objectives, the priority of the objectives, and the constraints; and
receiving from the computing device the portfolios as regenerated by the computing device based on the modification.

13. The method of claim 11, further comprising:
providing to the computing device a modification of which of the sub-plurality of the projects make up a selected portfolio of the portfolios; and
receiving from the computing device the selected portfolio as to which the portfolio value has been optimized by the computing device using a third model, while satisfying the constraints, based on the modification.

14. The method of claim 13, further comprising:
providing to the computing device a modification of the constraints,
wherein the portfolio value is optimized for the selected portfolio by the computing device using the third model also based on the modification of the constraints.

15. The method of claim 11, wherein:
the first model is a Pareto optimization model that is based on a basic optimization model, and
the second model is a multiple-criteria ranking optimization model that is also based on the basic optimization model.

16. A computing system comprising:
hardware, including a processor and memory;
a first component implemented by the hardware to store and permit modification of a plurality of constraints and a priority of a plurality of objectives; and
a second component implemented by the hardware to generate a plurality of portfolios including a plurality of first portfolios and a second portfolio, using a first model and a second model, each portfolio including a sub-plurality of a plurality of projects,
wherein the second component is to generate the first portfolios using the first model to optimize a portfolio value in consideration of the objectives under differing bounds of a sub-plurality of the objectives while satisfying the constraints,
and wherein the second component is to generate the second portfolio using the second model to optimize the portfolio value in consideration of the objectives with respect to the priority of the objectives while satisfying the constraints.

17. The computing system of claim 16, wherein responsive to the first component receiving a modification of one or more of the differing bounds, which of the objectives are part of the sub-plurality of the objectives, the priority of the objectives, and the constraints, the second component regenerates the portfolios based on the modification.

18. The computing system of claim 16, wherein responsive to the first component receiving a modification of which of the sub-plurality of the projects make up a selected portfolio of the portfolios, the second component optimizes the portfolio value for the selected portfolio using a third model, while satisfying the constraints, based on the modification.

19. The computing system of claim 16, wherein:
the first model is a Pareto optimization model that is based on a basic optimization model, and
the second model is a multiple-criteria ranking optimization model that is also based on the basic optimization model.
